(19) United States
(12) Patent Application Publication
(10) Pub. No.: US 2008/0273052 A1
(43) Pub. Date: Nov. 6, 2008

(54) METHOD AND SYSTEM FOR CONTROLLING PRINTING PROCESSES

(76) Inventor: Greg E. Imhoff, Western Springs, IL (US)

Correspondence Address: CARDINAL LAW GROUP, Suite 2000, 1603 Orrington Avenue, Evanston, IL, 60201, US

(21) Appl. No.: 11/775,010

(22) Filed: Jul. 9, 2007

Related U.S. Application Data
(60) Provisional application No. 60/916,161, filed on May 4, 2007.

(51) Int. Cl. B41J 2/205

(52) U.S. Cl. 347/15

(57) ABSTRACT

An apparatus for establishing ink application settings includes a Spectro-densitometer configured to determine neutral print value goals, an ink density and a correction display for matching advanced specification and improving accurate color matches. The apparatus further includes a controller configured to receive ink density readings from the spectro-densitometer, determine an ink control setting based on the received ink density readings, and display the ink control setting on the display. This is many component steps synthesized to accurately work together, at once to save many incremental and further steps in order to globally better match production prints to proofing color goals most efficiently.

### RELATED APPLICATIONS

This application claims the benefit of, and priority to, U.S. Provisional Patent Application 60/916,161, filed May 4, 2007, the entirety of which is incorporated by reference.

### TECHNICAL FIELD OF THE INVENTION

The present invention relates generally to printing and in particular to controlling application of ink during printing to match desired client proof colors.

### BACKGROUND OF THE INVENTION

Print operators are concerned with attaining both accurate, and consistent, color from presses. These concerns are aggravated in ‘high volume’ applications. However, application of ink is an exacting process, and made challenging by both inconsistencies in substrate compositions, ink pigments, as well as operator compliance.

Typically, ink is measured with reference to either 3 or 4 primary colors, called CMY (Cyan, Magenta, Yellow) or CMYK (Cyan, Magenta, Yellow, Black).

Historically, a press operator engages in a lengthy configuration process using experience and guess work to arrive at appropriate ink deposition settings for each of the CMY or CMYK inks. These traditional configurations include a lengthy span of time, and usage of a large volume of ink and paper. Typically, ink is applied based on the density of the ink, and the operator judges the results of the printing and adjusts the density controls for the CMY/CMYK printing, and iterates until there is a close match between the desired color and the actual color printing. A graphical representation of sample adjustments is illustrated in prior art FIG. 10.

Further complicating the printing configuration is differences in paper color and ink characteristics. Thus, replacing a roll of paper, adding a stack of new sheets or adding ink to the printing press or changing plates, blankets or dampener settings can alter the results, necessitating a new round of configurations. In addition, recent changes in standardized specifications for finding Neutral Print Density Curves (NPDC) references and results measurements of printed color targets, have affected the manner in which configurations are implemented. These changes result in different controls and require press operators to engage in additional technology, testing, and training, which is resisted.

Therefore, it would be desirable to provide a method and system of printing that would overcome the aforementioned and other disadvantages.

### SUMMARY OF THE INVENTION

One aspect of the invention provides a method for applying ink. The method includes receiving at least one image, determining at least one substrate characteristic of a first substrate, determining a first target setting based on the received image and determined substrate characteristic, applying ink to the first substrate based on the first target setting and determining an apparent gray balance of the applied inks. In addition, the method includes comparing the determined gray balance to the received image, determining a second target setting based on the first target setting and the comparison, and applying ink to a second substrate responsive to the second target setting.

Another aspect of the invention provides a computer usable medium storing a computer program including computer program code for defining new specifications with results in the operators preferred metrologies for applying inks. The medium includes computer program code for receiving at least one image, computer program code for determining at least one substrate characteristic of a first substrate, computer program code for determining a first target setting based on the received image and determined substrate characteristic, computer program code for applying ink to the first substrate based on the first target setting and computer program code for determining a gray balance of the applied ink variables. In addition, the medium includes computer program code for comparing the determined gray balance to the received image, determining a second target setting based on the first target setting and the comparison, and computer program code for applying ink to a second substrate responsive to the second target setting.

One aspect of the invention provides a system for applying inking levels. The system includes means for receiving at least one image, means for determining at least one substrate characteristic of a first substrate, means for determining a first target setting based on the received image and determined substrate characteristic, means for applying ink to the first substrate based on the first target setting and means for Spectrally and Densitometricaly compare to new color print specifications determining acceptable gray balance levels of the applied inks. In addition, the system includes means for comparing the determined gray balance to the received image, means for determining a second target setting based on the first target setting and the comparison, and means for applying ink to a second substrate responsive to the second target setting.

Yet another aspect of the invention provides an apparatus for establishing ink application settings. The apparatus includes a Spectrophotometer and Densitometer configured to determine all ink densities to match specifications for gray balance production matches of color on a portable display by spectral specifications and to call out Densities correction values and directions for all inks to the new print process goals, all complete. The apparatus solution further includes a controller configured to receive ink density readings from the densitometer, determine an ink control setting based on the received ink density readings, and display the ink control setting on the display.

The foregoing and other features and advantages of the invention will become further apparent from the following detailed description of the presently preferred embodiments, read in conjunction with the accompanying drawings. The detailed description and drawings are merely illustrative of the invention, rather than limiting the scope of the invention being defined by the appended claims and equivalents thereof.

### BRIEF DESCRIPTION OF THE DRAWINGS

FIG. 1 illustrates one embodiment of a method for applying ink, in accordance with one aspect of the invention;

FIG. 2 illustrates one embodiment of an apparatus for establishing ink application settings, in accordance with one aspect of the invention;

FIG. 3 illustrates one embodiment of an apparatus for establishing ink application settings, in accordance with one aspect of the invention;

FIG. 4 illustrates one embodiment of a display for the apparatus of FIG. 2 or 3, in accordance with one aspect of the invention;

FIGS. 5 and 6A illustrate various displays in accordance with an aspect of the invention;

FIG. 6B illustrates a conversion between LAB and HR_cmy values, with all Density directions in accordance with one aspect of the invention,

FIG. 7 illustrates the calibrations disclosed herein, in accordance with one aspect of the invention;

FIG. 8 illustrates the calibrations disclosed herein, in accordance with one aspect of the invention;

FIG. 9A illustrates one example of an adjustment 900 to HR_k to process print for image, in accordance with one aspect of the invention;

FIG. 9B illustrates exemplary targets for print values, in accordance with one aspect of the invention; and

FIG. 10 illustrates a prior art mapping of print adjustments.

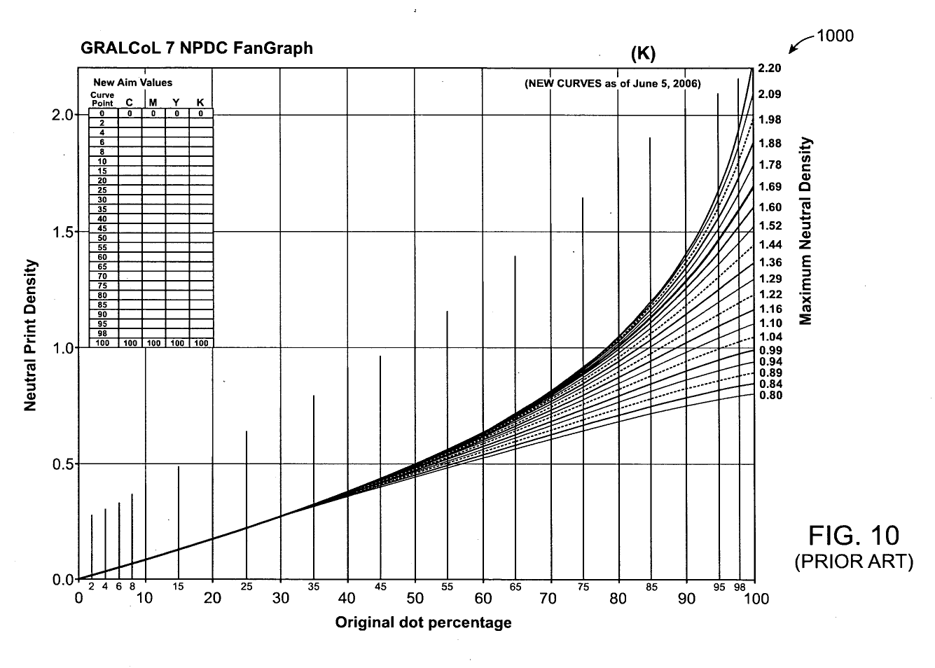

### DETAILED DESCRIPTION OF THE PRESENTLY PREFERRED EMBODIMENTS

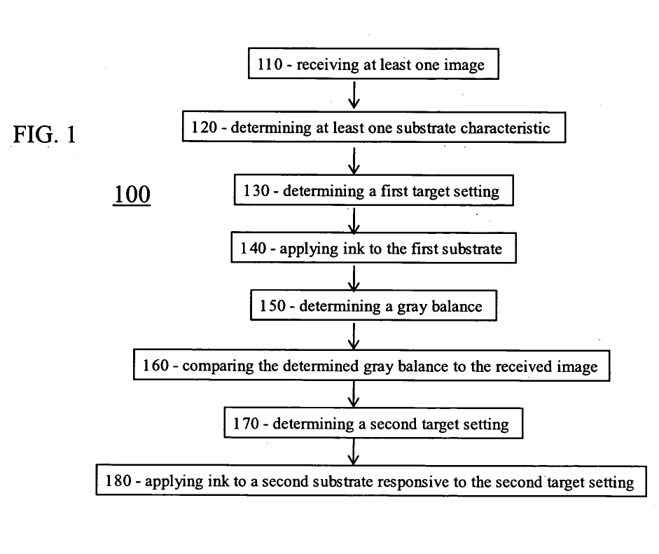

FIG. 1 illustrates one embodiment of a method 100 for applying ink in accordance with one aspect of the invention. Method 100 begins at step 110 by receiving at least one image. In one embodiment, the image includes at least one color. The image includes certain definable characteristics, such as brightness, contrast, spectral color and density values, and the like. The color is represented by CMY values, or CMYK values, in certain embodiments. In one embodiment, the color is measured by gray balance. In one embodiment, the gray balance is measured in accord with standards settings such as the G7 GRACoL neutral print density curve specifications, HR_CMY & HR_K. The received image is either received with its characteristics established, or the characteristics are established based on the received image.

The substrate characteristics of at least a first substrate are determined at step 120. In one embodiment, the first substrate is paper. In other embodiments, the substrate is implemented as an appropriate ink-carrying material, such as cardboard, plastics, or the like. The first substrate has a number of substrate characteristics including substrate color, substrate ink holding capacity, size, and the like. In another embodiment, the substrate characteristic includes porosity and/or bumpiness. In one embodiment, the determined substrate characteristics include color, although the determined substrate characteristics are not limited to color. In one embodiment, the characteristics of the substrate are determined with each change in paper, such as by changing rolls or from new stacks of paper.

A first target setting is determined based on the received image and the determined substrate characteristic at step 130. The first target setting includes settings for each component of the color to be printed, such as a CMY setting, CMYK setting, or the like. In other embodiments, the first target setting includes 1*a*b*, 1*u*v*, CIE, RGB, settings, or other print settings. In one embodiment, the first target setting includes inputs of a HR_k, HR_cmy, a*, b* target values to find and match the color goals. The first target setting governs the application of ink, such as a volume of each color ink applied, the density of application, which color is applied, and where the ink is applied. In one embodiment, the first target setting is manually applied to a printing press, while in other embodiments, the first target setting is electrically communicated to the printing press via a network connection.

Based on the first target setting, ink is applied to the first substrate at step 140. In one embodiment, the ink is applied with a printing press. In another embodiment, the ink is applied electronically with a digital proof. The ink or colorants can be applied using any appropriate control device or technique. After the ink is applied, method 100 determines the gray balance of the applied ink at step 150 comparing results to input values under #26, adding directional Density adjustments to match the goals at press. In one embodiment, a spectro-colorimeter determines the gray balance of the applied ink. In other embodiments, a densitometer determines the gray balance of the applied ink. The determination is made, in one embodiment, using a movable device, such as a handheld unit. In other embodiments, the determination is made using a mounted device in line with the printing press. In one embodiment, the determination of the gray balance includes taking a colorimetric reading of the applied ink and converting the calorimetric reading to a standardized gray balance, such as a GRACOL 7 standard specifications. In another embodiment, determining the gray balance includes taking a spectral reading of the applied ink and converting the spectral reading to a standardized gray balance, such as a GRACOL standard specifications. In other embodiments, the color density of the applied ink is measured. In one such embodiment, the last measurement for each color constituent (i.e. the last C, last M, last Y and last K measurement) is stored in a memory and compared to either future, previous, or both gray balance measurements of the result color constituent for density adjustments. In yet other embodiments, dot density values are determined based on the applied ink to identify and control complex screening technologies to best match neutral (NPDC) tone gray balance ranges on varying substrates and processes be it Offset, Flexography or Gravure Printing.

Having determined the gray balance of the applied ink, method 100 compares the determined gray balance to the received image at step 160. In the event that the gray balance of the received image is not the same as the determined gray balance, a second target setting is determined based on the first target setting and the comparison at step 170. The second target setting is a modified setting based on the first target setting. In one embodiment, the second target setting is determined responsive to adjust the determined gray balance to equal the gray balance of the received image. These modifications can take the form of increasing or decreasing ink components, such as one or more of the CMYK inputs. For example, if the determined gray balance indicates an overabundance of cyan, the “c” control is reduced a fraction estimated to normalize the presence of “c” so that the gray balance of the applied ink is correctly matched to the gray balance of the received image. Thus, in one embodiment, the ink applied in the future will more accurately match the client approved proof as close as visually possible precisely with the help of the new specifications. In one embodiment, these modifications result in absolute directions now needed in numerical and graphical form in each language tool for best understood color matches of any production runs.

Ink is then applied to a second substrate responsive to the second target setting at step 180. In one embodiment, the gray balance of the ink applied to the second substrate is determined, similarly as in step 150, and compared to the received image, similarly as in step 160. In such a fashion, the target settings are iteratively adjusted to equalize the gray balance of the received image and the ink deposited on a substrate. The characteristics, such as color, of the substrate are included in the estimation and comparison. In this fashion, the proper configuration for the application of ink to the substrate is realized with reduced reliance on trial and error techniques practiced in the art. Additionally, the configuration is less reliant on the subjective skill of the press operator.

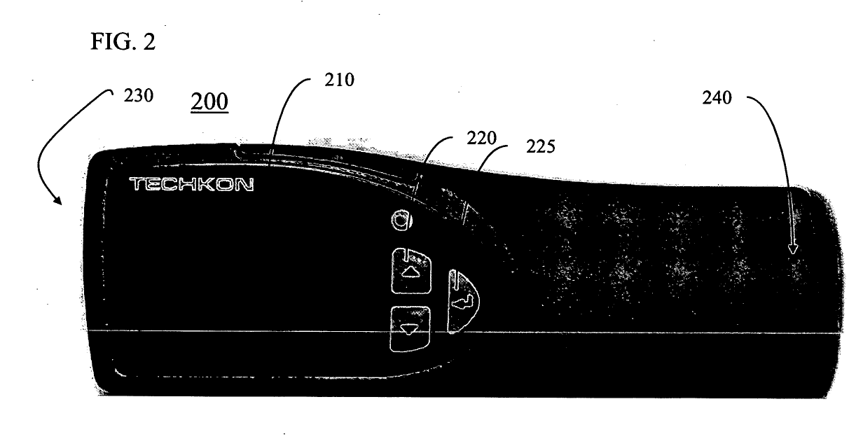

FIG. 2 illustrates one embodiment of an apparatus 200 for establishing ink application settings, in accordance with one aspect of the invention. As illustrated, apparatus 200 is a hand held device although the <device> solution can be implemented in line within a printing press.

Apparatus 200 includes a display 210 and a user interface 220. The user interface is configured to receive user instructions, such as via buttons 225. In addition, the apparatus includes a densitometer 230 configured to determine an ink density. The densitometer 230, user interface 220, and display 210 are in electrical communication with a controller configured to receive ink density readings from the densitometer and determine an ink control setting based on the received ink density readings and to display the ink control setting on the display.

In one embodiment, apparatus 200 includes a press interface 240 in electrical communication with the controller. The press interface 240 communicates a determined ink control setting to a printing press controller to automatically adjust ink control settings responsive to the determined ink density readings. In one embodiment, the press interface 240 includes a USB connection, or other such computer networking connection. In one embodiment, the computer network allows for monitoring of the print control settings for a plurality of printing presses at a central location.

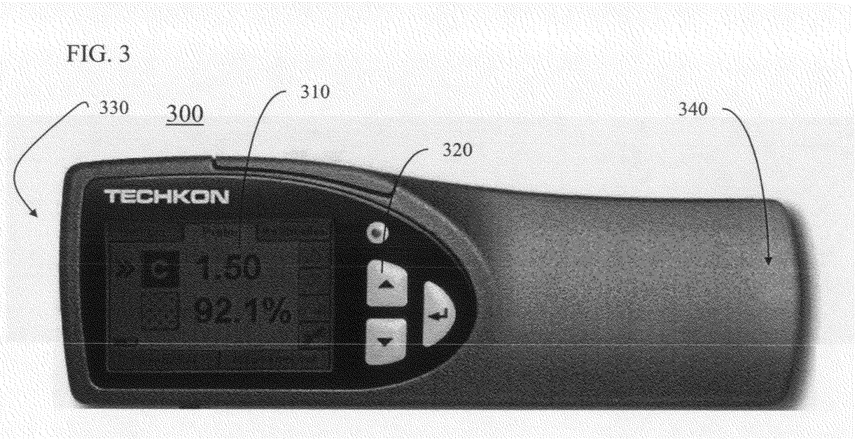

FIG. 3 illustrates one embodiment of an apparatus 300 for establishing ink application settings, in accordance with one aspect of the invention. As illustrated, apparatus 300 is a hand held device, although the device can be implemented in line within a printing press.

Apparatus 300 includes a display 310 and a user interface 320. The user interface is configured to receive user instructions, such as via buttons 225. In addition, the apparatus includes a spectrodensitometer 330 configured to determine ink densities, spectral color space values and new iG-7 or G-7 specifications with ink flow directions, to match the desired neutral print specification goal sets. The calorimeter 330, user interface 320, and display 310 are in electrical communication with a controller configured to receive ink density readings from the spectro-densitometer and determine an ink control setting based on the received ink density readings and to display the ink control setting on the display.

In one embodiment, apparatus 300 includes a press interface 340 in electrical communication with the controller. The press interface 340 communicates a determined ink control setting to a printing press controller to automatically adjust ink control settings responsive to the determined ink density readings. In one embodiment, the press interface 340 includes a USB connection, or other such computer networking connection. In one embodiment, the computer network allows for monitoring of the print control settings for a plurality of printing presses at a central location.

In other embodiments, the densitometer 230 and/or spectro-colorimeter 330 include additional functions. In one embodiment, the densitometer 230 and/or spectro-colorimeter 330 are configured to automatically measure density, determine CMYK density, determine a dot area, dot gain, and grey and/or color balance. Additionally, certain embodiments of the apparatus are configured to determine printing contrast. Other embodiments are configured to determine the spectral density of Pantone type special colors. Other embodiments are configured to determine a print characteristic curve based on ISO standards. Other embodiments are configured with tolerance ranges, either standard or customizable. Other embodiments are configured to determine the dot gain in accordance with Yule-Nielsen rules. Other embodiments are configured to determine the level of trapping in accordance with Frank Preucil, Brunner and Ritz rules. Other embodiments are configured to determine the density spectrum curve, as well as CIELab, DEab, XYZ, and color circles. Each of these characteristics can then be used to configure the ink controls settings appropriate to achieve the ink densities appropriate for the received image.

In one embodiment, the densitometer 230 and/or calorimeter 330 are implemented as a spectrophotometer. In one such embodiment, the densitometer 230 and/or Spectro-colorimeter 330 are implemented with the ability to determine additional characteristics such as CIE LChab, xyY,Luv, LChuv, DIN Lab 99, DE 94, DE 2000, DE 99, DE cmc, DE uv, Metamerism-Index, Whiteness, Yellowness, Pass-/Fail-Tolerance, Average values, ISO and GRACoL G7 color guide analysis recommendations for corrective density adjustments with upper and lower control limits and preferred defaults.

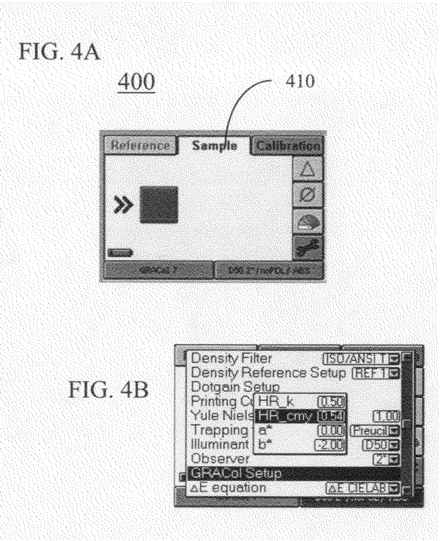

FIG. 4A illustrates one embodiment of a close up view of a display 410, such as apparatus 210, 310. As shown, display 410 shows 3 modes—a Stored G7 (FIG. 4B) reference modes for determining the properties of the reference image, a sample mode for determining the gray balance of the applied ink, and a calibration mode for ensuring that the measurements made by the apparatus are properly calibrated and adjusted illumination and viewing standards such as ISO 12647 and or GRACoL G7 specifications and the like. Operation between the modes is determined by input from the user interface 220, 320.

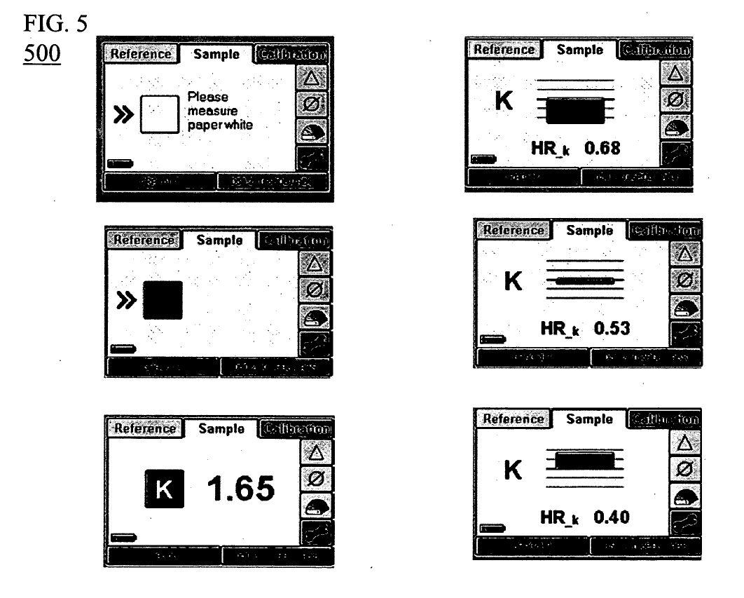

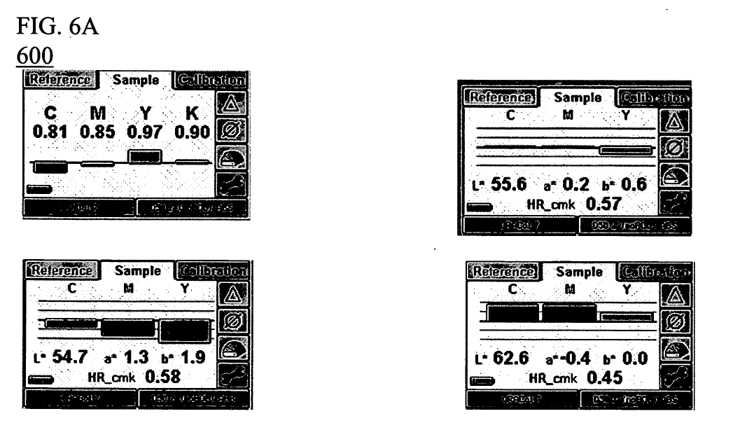

FIG. 5 illustrates a series of screen shots 500 of the display 410 iterating an embodiment of method 100, in accordance with one aspect of the invention. As shown, the apparatus determines the substrate characteristics (“measure paper white”), and prepares to receive the measurements of the applied ink and combined inks. The gray balance “K 1.65” represents anything out of preset 25% upper & lower control limits, automatically defaulting into the press operators preferred realm of Density values. When inks match normal ranges of the new standard G-7 targets the applied ink results are determined such as using an HR_k net value. In the event that the applied ink is off target, the CMYK values are shown in graphical adjustments to attain the target characteristics by increasing, decreasing, or failing to correctly adjust ink application settings Densitometry only values are then displayed. Similarly, FIG. 6A illustrates exemplary ink flow adjustments to CMYK print densities, as well as the keys to L*a*b* and GRACoL value settings controls and help.

FIG. 6B illustrates GRACoL conversion steps between L*a*b* and HR_cmy values, in accordance with one aspect of the new specifications this invention universally simplifies use, adding value. Prior to this one GRACoL tool for matching colors to the new specs (HR_cmy or HR_k) for ink level adjustments to Spectral color space for matching colors on press gray balance control required operators to both have a new SpectroDensitometer measuring tool and, to look up then seek find and compare from LAB which ways to move ink densities, from an arrow conversion chart as presented in FIG. 6B. The methods disclosed herein removes this guesswork by a press operator to more quickly direct and efficiently arrive at the required adjustments based upon the new specification goals sets and to their individual operating conditions.

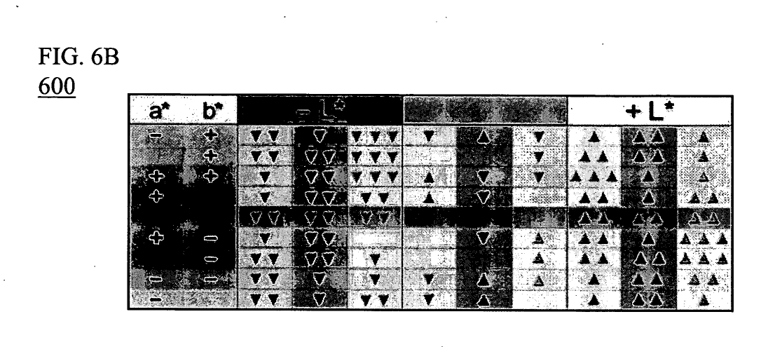

FIGS. 7A and 7B illustrate an offset press before G7 calibration (FIG. 7A) and after (FIG. 7B) showing NPDC (Neutral Print Density Curve). As can been seen, prior to the G7 calibration, the print wanders from the desired proof, while the print stays remarkably close the proof using the calibration techniques described herein.

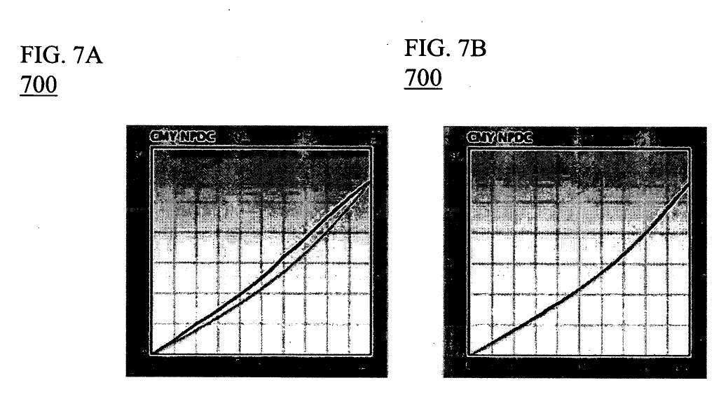

FIG. 8 illustrates can adjustment 800 to gray balance (HR_cmy) in accordance with an aspect of the invention. Solid ink densities (or another press variable) are adjusted within permitted tolerances until the HR_cmy patch (50 c, 40 m, 40 y) is as close as possible to the spectral a* (Red+ or Green− axis), and or b* (Blue− or Yellow+ axis), values to match the neutral gray balance aim points for ND (Neutral Densities) L* (Lightness+ to Darkness−) apparent colorant aim value points. This process executes iteratively since numerous factors can combine to misalign settings, including changes in paper characteristics, changes in ink characteristics, and even weather related factors.

As further seen in FIG. 8, minor HR_cmy point shifts seen may also help to (0.56 & 0.57) illustrate how Gray Balance as a goal on press, may be difficult to achieve from different ink sets and varying conditions. The iterative execution of the methods disclosed herein use existing standards and the new GRACoL G7 specifications to serve as a helpful “bridge” quickly directing press operators in their preferred operating language densities, graphically and with spectral values to achieve to the G7 neutral print goal benefits, while not interfering with lost training, look up table conversions, saving press run wastages in time and materials, adds value added profits, resulting in higher quality end prints for improved overall productivities.

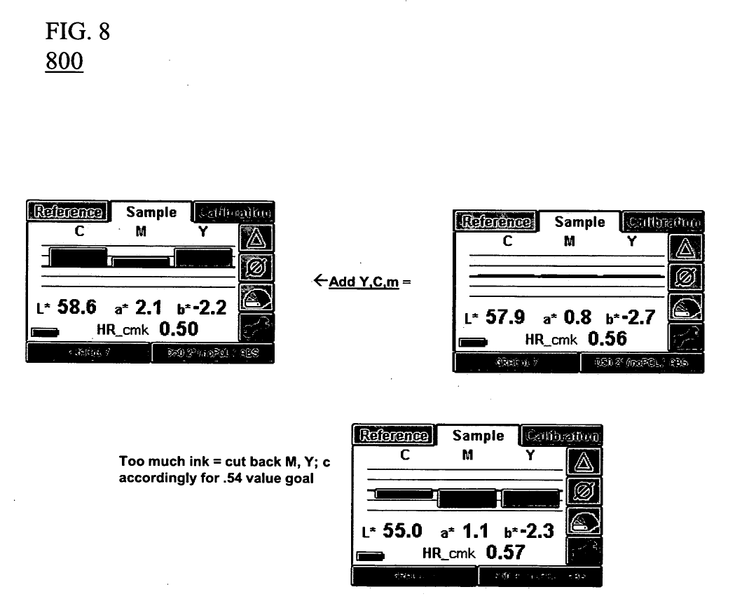

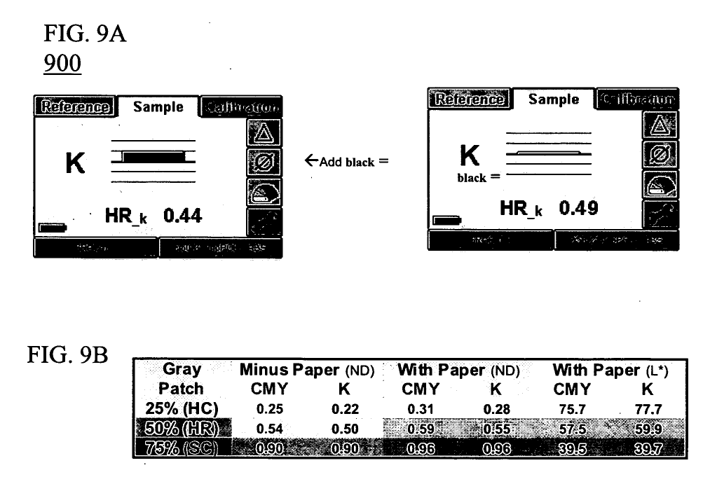

FIG. 9A illustrates one example of an adjustment 900 to HR_k to process print for image, in accordance with one aspect of the invention. As seen at 900, the black solid ink density (or another press variable) is adjusted until the HR_k patch (50% k target) is as close as possible to the nominal HR_k aim point (0.50 spec).

FIG. 9B illustrates additional targets for highlight (25%) and shadow (75%) print ranges of CMY and K with HR_cmy and HR_k midtone images. These targets are utilized in one embodiment for control measuring color targets for all ranges most efficiently known as Color Bars on reporting press production process conditions.

Those of skill in the art will recognize that the disclosures herein result in elimination of extra steps needed in finding from measuring, applying and predicting color. In present condition for the G7 spec one needs to find the new standard print specifications and how their press prints, in order to hit the “ideal” curve sets through a wide if not entire range minimums of Highlights, Midtones and Shadows known as finding and then setting the Natural Density Print Curves (NPDC) daily changing variables. Using the image contrast and brightness reproductions as outlined herein, instead of densities with or without dot gain curves such as tonal value increase (“TVI”) for each CMYK or other colors, is now simplified. In other words, the disclosures herein match neutral color matching with universally accepted balanced gray colors on press or proof without needing to image new plates, reduces lost time on color changes from hunt and guess attributes all in order to attain the preferred production gray balance results HR_cmy 0.54 or HR_k 0.50, for any press and shifting colorant paper stocks. These disclosures effectively bridge G7 specifications to reduce the need to use absolute spectral based color space interpretations for printing processes with absolute gray balance for all colors used within preferred process densities most efficiently from omnipotent Mid-tone areas, all in one (1) step not achieved prior to these disclosures.

In accordance with these disclosures, G7 specifications on press features of color space calculations applied to move ink keys to match the NPDC goals from the calorimetric calculations of HR_formulas best match of process colors, for the specified neutral print colors. Midtone targets represent image reproduction across all process ranges and match to operator control target expectations on press. In addition conversion of color data back into Densitometric values with graphical help enables the operator to efficiently adjust moves to hit desired colors positively (up or down as is—not where it was) now for the first time from absolute values and in preferred language too.

In addition quick color calculations featuring HC_cmy and HC_k and SC_k and SC_cmy calculations may also be added.

It is important to note that the figures and description illustrate specific applications and embodiments of the present invention, and is not intended to limit the scope of the present disclosure or claims to that which is presented therein. Upon reading the specification and reviewing the drawings hereof, it will become immediately obvious to those skilled in the art that myriad other embodiments of the present invention are possible, and that such embodiments are contemplated and fall within the scope of the presently claimed invention.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

I claim:

1. A method of applying ink, the method comprising:
Receiving at least one image;
determining at least one substrate characteristic of a first substrate;
determining a first target setting based on the received image and determined substrate characteristic;
applying ink to the first substrate based on the first target setting;
determining a gray balance of the applied ink;
comparing the determined gray balance to the received image;
determining a second target setting based on the first target setting and the comparison; and
applying ink to a second substrate responsive to the second target setting.

2. The method of claim 1 wherein determining the first target setting comprises:
establishing a HR_k target value; and wherein determining the second target setting comprises:
modifying the HR_k target value.

3. The method of claim 1 wherein determining the gray balance comprises:
taking a spectral reading of the applied ink; and
converting the spectral reading to a standardized gray balance.

4. The method of claim 3 wherein the standardized gray balance is one of a GRACOL standard and HR_CMY.

5. The method of claim 1 wherein determining the gray balance comprises:
taking a calorimetric reading of the applied ink; and
converting the calorimetric reading to a standardized gray balance.

6. The method of claim 5 wherein the standardized gray balance is a GRACOL standard.

7. The method of claim 1 wherein determining the first target setting comprises:
establishing a CMYK target value; and wherein determining the second target setting comprises:
modifying the CMYK target value.

8. A computer usable medium storing a computer program including computer program code for applying ink, the medium comprising:
computer program code for receiving at least one image;
computer program code for determining at least one substrate characteristic of a first substrate;
computer program code for determining a first target setting based on the received image and determined substrate characteristic;
computer program code for applying ink to the first substrate based on the first target setting;
computer program code for determining a gray balance of the applied ink;
computer program code for comparing the determined gray balance to the received image;
determining a second target setting based on the first target setting and the comparison; and
computer program code for applying ink to a second substrate responsive to the second target setting.

9. The medium of claim 8 wherein determining the first target setting comprises:
computer program code for establishing a HR_k target value; and wherein determining the second target setting comprises:
computer program code for modifying the HR_k target value.

10. The medium of claim 8 wherein computer program code for determining the gray balance comprises:
computer program code for taking a spectral reading of the applied inks; CMY into spectrally neutral color space results for matching HR_CMY gray specifications and
computer program code for converting the spectral reading to match CMY ink levels in preferred method of ink densities in one step to the standardized gray balance.

11. The medium of claim 8 wherein computer program code for determining the gray balance comprises:
computer program code for receiving a calorimetric reading of the applied ink; and
computer program code for converting the calorimetric reading to a standardized gray balance.

12. The medium of claim 8 wherein computer program code for determining the first target setting comprises:
computer program code for establishing a CMYK target value from spectral based color space and wherein determining the second target setting comprises:
computer program code for modifying the CMYK target value based on at least one specification.

13. A system for applying ink, the method comprising:
means for receiving at least one image;
means for determining at least one substrate characteristic of a first substrate;
means for determining a first target setting based on the received image and determined substrate characteristic;
means for applying ink to the first substrate based on the first target setting;
means for determining a gray balance of the applied ink;
means for comparing the determined gray balance to the received image;
means for determining a second target setting based on the first target setting and the comparison; and
means for applying ink to a second substrate responsive to the second target setting.

14. An apparatus for establishing ink application settings, the apparatus including:
a Spectrodensitometer configured to determine an ink density;
a display; and
a controller configured to receive ink density readings from the Spectro-densitometer, determine an ink control setting based on the received ink density readings, and display the ink control setting on the display.

15. The apparatus of claim 14 further comprising:
a press interface in electrical communication with the controller, the press interface configured to communicate the determined ink control setting to a printing press controller.

16. The apparatus of claim 15 wherein the press interface comprises a USB connection.
